(19) United States
(12) Patent Application Publication
(10) Pub. No.: US 2015/0099014 A1
(43) Pub. Date: Apr. 9, 2015

(54) METHOD FOR PREPARING BIOCIDAL AND ANTIFOULING AQUEOUS COMPOSITIONS COMPRISING HYDROBROMIC ACID, UREA AND SODIUM HYPOCHLORITE

(71) Applicant: BROMINE COMPOUNDS LTD., Beer Sheva (IL)

(72) Inventors: Shlomo Antebi, Haifa (IL); David Feldman, Haifa (IL); Chen Zolkov, Kiryat Tivon (IL)

(21) Appl. No.: 14/382,386

(22) PCT Filed: Mar. 6, 2013
(86) PCT No.: PCT/IL2013/050206

§ 371 Date: Sep. 2, 2014

Related U.S. Application Data
(60) Provisional application No. 61/608,189, filed on Mar. 8, 2012.
(60) Provisional application No. 61/616,671, filed on Mar. 28, 2012.

(51) Int. Cl. A01N 59/00; A01N 47/28

(52) U.S. Cl. CPC A01N 59/00; A01N 47/28
USPC 424/722

(57) ABSTRACT

The invention provides a biocidal and antifouling composition comprising hydrobromic acid, urea and sodium hypo-chloride from highly concentrated precursors and a process for manufacturing the composition.

### FIELD OF THE INVENTION

The present invention relates to biocidal and antifouling aqueous solutions combining biocidal effects of low pH and active bromine.

### BACKGROUND OF THE INVENTION

An undesired accumulation of organisms or organic residues in liquid volumes or on wet surfaces is controlled by a variety of methods, including mechanical treatments, modifying water concentration, applying organic and inorganic biocidal materials, changing temperature, etc. There is perpetual demand for new methods, because known methods are not always applicable, and new situations incessantly appear, as well as new or resistant contaminants. Active chlorine is popular, frequently in the form of hypochlorite alkali solutions. Alkali solutions are not always desirable, and also it was observed that active bromine is biocidally more efficient than active chlorine. It is therefore an object of the invention to provide a method for manufacturing a biocidal composition based on active bromine.

It is another object of the invention to provide means for achieving very high biocidal effect on the site of need, eventually by combining simple and available precursor.

Other objects and advantages of present invention will appear as description proceeds.

### SUMMARY OF THE INVENTION

The invention provides a method for manufacturing a biocidal and antifouling composition in an aqueous mixture for treating industrial waters, comprising the steps of i) providing aqueous solution A containing HBr at a concentration of between 5 wt % and 30 wt %, and urea at a weight ratio of urea/HBr of at least 0.3; ii) providing aqueous solution B comprising NaOCl; and iii) combining said aqueous solutions A and B; wherein said weight ratio of urea/HBr is not higher than 3, and wherein said solutions A and B are combined, optionally with an amount of additional water, in such a ratio of volumes as to provide a pH lower than 6.0. Said pH is usually lower than 5, depending on the dilution of solutions A and B in the treated waters, possibly lower than 4. In concentrated mixtures, usable as stock solutions, the pH may be 3 or lower, possibly 2.5 or lower such as 2.0 or lower.

The invention relates to a method for manufacturing a biocidal and antifouling composition in an aqueous mixture, the method comprising the steps of i) providing aqueous solution A containing HBr at a concentration of between 5 wt % and 30 wt %, and urea at a weight ratio of urea/HBr of at least 0.3; ii) providing aqueous solution B containing sodium hypochlorite (NaOCl) in an amount corresponding to a weight ratio of NaOCl (as Cl2) to said HBr in said solution A of from 0.3 to 0.9; and iii) providing said aqueous mixture by combining said aqueous solutions A and B, the solutions A and B being preferably in equal volumes, with an amount of additional water; wherein said solutions A and B create an acidic pH in said aqueous mixture and active bromine in a concentration of up to 20 wt %. According to the practical needs, the invention provides aqueous solutions containing active bromine in a concentration of 12.5 wt % or less, for example 0.1-12.5 wt %, such as 2-8 wt %, or 300-1000 ppm, or 20-1000 ppm, or 20-300 ppm, or 1-20 ppm, or 1-10 ppm, or 0.1-10 ppm. In the first aspect of the invention, said amount of additional water is not higher than the quantity of solutions A and B, and said aqueous mixture has a very low pH, for example 3.0 or less, and contains a very high concentration of the biocidal species, reaching the highest value in a limiting case when said amount of additional water approaches zero. In one embodiment of the first aspect, said amount is a predetermined amount of water adjusting the concentration of the biocidal composition to a desired value, resulting in a mixture ready as a concentrated stock, for example having active bromine of between 0.1 and 20 wt %, usually between 1 and 20 wt %, for anti-fouling treatment in additional aqueous mixtures into which the stock is admixed. In the second aspect of the invention, said amount of additional water in step iii) is higher than the quantity of solutions A and B, and said aqueous mixture contains biocidal species in various dilutions sufficient to prevent or inhibit or eliminate biofouling in the mixture and on the surfaces in contact with the mixture. In one embodiment of the second aspect, said amount of additional water comprises an excess of water in a container or stream to be treated, resulting in an aqueous mixture having an acidic pH and active bromine down to 20 ppm or less, for example down to between 0.1 and 10 ppm.

The invention relates to a method for disinfection of an aqueous mixture, and for preventing or eliminating biofouling in an aqueous mixture, the mixture comprising effluent water, or waste water, or industrial or agricultural water in a container or in a circuit, comprising steps of i) admixing solution A into said aqueous mixture, wherein said solution A contains HBr at a concentration of between 5 wt % and 30 wt % and urea at a weight ratio of urea/HBr of from 0.3 to 3; and ii) admixing solution B into said aqueous mixture, wherein said solution B contains an oxidizer, preferably sodium hypochlorite (NaOC1) in an amount corresponding to a weight ratio of NaOCl to said HBr in said solution A of from 0.3 to 0.9; thereby creating active bromine in said mixture. The invention, in one preferred embodiment, relates to a method for disinfection of an aqueous mixture in contact with meat and poultry, and for preventing or eliminating biofouling on a surface of said meat and poultry, comprising steps of i) admixing solution A into said aqueous mixture, wherein said solution A contains HBr at a concentration of between 5 wt % and 30 wt % and urea at a weight ratio of urea/HBr of from 0.3 to 3; ii) admixing solution B into said aqueous mixture, wherein said solution B contains an oxidizer, preferably sodium hypochlorite (NaOCl) in an amount corresponding to a weight ratio of NaOCl to said HBr in said solution A of from 0.3 to 0.9; thereby creating active bromine in said mixture; optionally diluting any of said solutions A and B before their combining or after with pure water; and contacting said meat or poultry with said mixture.

The mixture may comprise a water bulk or a water stream, and said solutions A and B may be admixed in any order, or simultaneously. In one embodiment of the invention, one of the solutions is injected to a water system, and only after dispersing said solution and reaching essentially homogeneity, the other solution is injected to produce the biocidal composition comprising biocidal species in concentrations sufficient for disinfection and to inhibit or eliminate biofouling. The injections of the solutions may be performed simultaneously or in any order, possibly repeatedly. The volumes of injected solutions A and B will be calculated to provide for the desired final active halogen concentration in the treated water and for the desired reagent ratios. In a preferred arrangement, the volumes of solutions A and B will equal.

Without limiting themselves to any particular theory, the inventors believe that superior anti-biofouling effects of the method of the invention, result not only from the combined activities of low pH and active halogen in killing the organisms, but also from chemical effects of acidic pH on the reactions between active bromine and urea. It is noted that as far as the reagents are employed in accordance with the method of the invention, surprisingly effective antifouling results are achieved, regardless whether the reagents are incorporated into the system simultaneously or separately in any order, and regardless whether the reagents are premixed before injecting into the treated water system or incorporated separately.

The invention provides a method for manufacturing an aqueous biocidal and antifouling composition comprising the step of i) admixing hydrobromic acid (HBr) and urea into water or aqueous mixture, wherein the amount of admixed HBr corresponds to a final concentration of between 5 wt % and 30 wt %, and wherein the amount of admixed urea corresponds to a weight ratio of urea/HBr of at least 0.3 and not higher than 3; and ii) admixing sodium hypochlorite (NaOCl) directly into the solution obtained in step i) or after diluting said solution of step i) in an amount corresponding to a weight ratio of NaOCl (as Cl₂)/HBr of between 0.3 and 0.9; thereby obtaining an aqueous solution comprising up to 20 wt % active bromine and a pH of 3.0 or less. In some embodiments, said steps i) and ii) may comprise adding additional water to solutions A and/or B before their admixing to said aqueous mixture.

Said hydrobromic acid may be added into water or into an aqueous mixture of urea, being in the form of gas or a water solution. Said urea may be added into water or into an aqueous solution of HBr, being in the form of a solid or a water solution or suspension. In a preferred embodiment of the invention, solid urea is admixed into an aqueous solution of HBr. Said NaOCl may be admixed into said water solution, comprising HBr and urea, as an alkali water solution, such as a commercially available mixture. In a preferred embodiment of the invention, said biocidal composition has a pH of 2.5 or less. In one embodiment of the invention, said urea/HBr ratio may be between 0.75 and 1.5, in other embodiment between 1.5 and 2.5. In the method according to the invention, the combined solutions A and B provide an acidic pH; the pH may be 3 or less, such as 2.5 or less, in concentrated mixtures, also usable as stock solutions, whereas in the treated containers or streams the pH may be 4 or less, or eventually 5 or less, or at very low concentrations of active halogen the pH may be 6 or less. In some embodiments of the invention, the stock solutions A and B will be employed by a skilled chemist in such a way, that preliminary mixing tests will decide the mixing ratios in order to provide the required pH.

In one aspect of the invention, provided is a method comprising the steps of i) admixing hydrobromic acid (HBr) and urea into water or aqueous mixture, wherein the amount of admixed HBr corresponds to a final concentration of between 10 wt % and 30 wt %, and wherein the amount of admixed urea corresponds to a weight ratio of urea/HBr of at least 0.3 and not more than 3, such as between 1 and 3, or between 2 and 3, thereby obtaining a solution having a pH of 0.0 or less; and ii) admixing sodium hypochlorite (NaOCl) into said aqueous mixture or into the solution obtained in step i) in an amount corresponding to a weight ratio of NaOCl (as Cl₂)/HBr of between 0.3 and 0.9; thereby obtaining an aqueous solution comprising up to 20 wt % active bromine and a pH of 1.5 or less. In another aspect of the invention, provided is a method comprising i) admixing hydrobromic acid (HBr) and urea into water or aqueous mixture, wherein the amount of admixed HBr corresponds to a final concentration of between 5 wt % and 10 wt %, and wherein the amount of admixed urea corresponds to a weight ratio of urea/HBr of between 2 and 3, thereby obtaining a solution having a pH of 1.5 or less; and ii) admixing sodium hypochlorite (NaOCl) into said aqueous mixture or into the solution obtained in step i) in an amount corresponding to a weight ratio of NaOCl/HBr of between 0.3 and 0.9; thereby obtaining an aqueous solution comprising up to 8 wt % active bromine and a pH of 2.5 or less. In still another aspect of the invention, provided is a method comprising i) admixing hydrobromic acid (HBr) and urea into water or aqueous mixture, wherein the amount of admixed HBr corresponds to a final concentration of between 5 wt % and 15 wt %, and wherein the amount of admixed urea corresponds to a weight ratio of urea/HBr of between 0.3 and 3, thereby obtaining a solution having a pH of 1.5 or less; and ii) admixing sodium hypochlorite (NaOCl) into the solution obtained in step i) in an amount corresponding to a weight ratio of NaOCl/HBr of between 0.3 and 0.9, thereby obtaining an aqueous solution comprising up to 12.5 wt % active bromine.

In other preferred embodiment, the invention is directed to a method providing a biocidal and anti-biofouling composition for treating industrial and agricultural water and a system containing said water, possibly by creating the biocidal halogen in situ, for example by combining at least two liquid streams, one of which comprises aqueous solution of HBr and the other aqueous solution of NaOCl; preferably, one of the streams comprises aqueous solution of HBr and urea, and the other stream comprises an aqueous solution of NaOCl. The solutions may be introduced into the system consecutively in any order, or in parallel, possibly by injecting stock solutions to a tank or a circuit, whose surface needs the anti-biofouling treatment or which contains water to be treated.

In one aspect, the invention provides a method for preparing a biocidal composition comprising active bromine. In a preferred embodiment, the method comprises combining HBr, urea, and sodium hypochlorite, wherein the components may be combined in any order. Urea is preferably present in the same concentration as HBr, or in an excess, but not more than 3 weight parts of urea per 1 weight part of hydrobromic acid. Sodium hypochlorite is preferably present at a concentration lower than said HBr, but not less than 0.4 weight parts of NaOCl per 1 weight part of HBr. While keeping the above ratios, the method of the invention in one aspect provides a highly concentrated solution comprising up to 30 wt % HBr and up to 20 wt % active bromine. In another aspect of the invention, provided is an acidic biocidal solution comprising down to 10 ppm active bromine in a location where the biocidal activity is desired; in other applications the acidic biocidal solution provided according to the invention comprises down to 1 ppm active bromine in a location where the biocidal activity is desired; in some applications the acidic biocidal solution provided according to the invention comprises down to 0.1 ppm active bromine in a location where the biocidal activity is desired. Said active bromine at a low but still biocidally active concentration is prepared by diluting said highly concentrated solution or by combining diluted solutions comprising HBr, urea, and NaOCl, in any order, possibly in a batch arrangement, or in the form of several liquid streams to be combined. In another preferred embodiment, industrial water is treated by a composition according to the invention, wherein one or two of said three components are present in said industrial water before the start of the treatment, and two or one remaining components are added directly or from stock solutions to said water to be treated, thereby completing the concentrations of all three components to the ranges according to the invention, thereby creating active bromine species and treating said water.

The invention provides an aqueous biocidal and antifouling composition comprising a mixture of hydrobromic acid (HBr), urea, and a commercial oxidizer, like sodium hypochlorite (NaOCl), wherein said HBr is added to an amount corresponding to a final concentration of between 5 wt % and 30 wt % in a solution A, urea is added to an amount corresponding to a weight ratio of urea/HBr of at least 0.3 and not more than 3; and NaOCl is added to the solution A to an amount corresponding to a weight ratio of NaOCl (as Cl₂)/HBr of between 0.3 and 0.9. The biocidal composition of the invention contains a high concentration of active bromine, up to 20 wt %. The biocidal composition of the invention exhibits a high acidity, having a pH of 3.0 or less. A biocidal composition according to the invention may act synergistically against biofouling agents by means of high active halogen combined with high acidity, having an active bromine of at least 12.5 wt % and a pH of 3 or less, such as 2.5 or less. The biocidal and antifouling composition according to the invention usually comprises, after combining solutions A and B, urea between 1 and 20 wt %, HBr between 0.5 and 10 wt %, and total chlorine between 0.4 and 8 wt %. In one embodiment, the biocidal and antifouling composition according to the invention comprises, after combining solutions A and B, HBr from 4 to 12 wt %, urea from 4 to 16 wt %, active bromine from 2 to 8 wt %, and a pH of 3.0 or less. In other embodiment, the biocidal and antifouling composition according to the invention comprises HBr from 4 to 12 wt %, urea from 4 to 16 wt, total chlorine from 1 to 4 wt %, and a pH of 3.0 or less. The amounts in wt % relate to the initial quantities in gram of said components per 100 gram of the final composition. This disregards the chemical changes that occur, but a skilled person understands that initial urea is at least partially converted to bromourea, initial active chlorine to sodium chloride, etc.

The invention is directed to a method of cleaning, and a method of disinfecting, and a method of preventing/removing biofilm accumulation, in industrial and agricultural equipments, comprising contacting the surfaces or volumes to be cleaned with an aqueous composition containing a high active halogen and high acidity.

In a preferred aspect, the invention provides a method for manufacturing a biocidal and antifouling composition in an aqueous mixture, wherein said aqueous mixture comprises industrial waters selected from cooling water, water for agricultural use, effluent water, water in paper mill process, industrial process water, production aqueous stream, irrigation water, or waste water; the method comprises steps of i) providing aqueous solution A containing HBr at a concentration of between 5 wt % and 30 wt %, and urea at a weight ratio of urea/HBr of at least 0.3 and not more than 3; ii) providing aqueous solution B containing NaOCl in an amount corresponding to a weight ratio of NaOCl (as Cl₂) to said HBr in said solution A of from 0.3 to 0.9; and iii) combining said aqueous solutions A and B, optionally after dilution, with said industrial waters, wherein said solutions A and B create an acidic pH in said aqueous mixture and active bromine in a concentration of between 20 ppm and 20 wt %.

The invention provides a biocidal technology and biocidal system for treating industrial waters, production aqueous streams, cooling towers, waters in pulp and paper industry, effluent waters, irrigation systems and agricultural equipments, and meat and poultry products, comprising two aqueous solutions, A and B, the former containing HBr at a concentration of between 5 wt % and 30 wt % and urea at a weight ratio of urea/HBr of at least 0.3 and not higher than 3, and the latter containing sodium hypochlorite (NaOCl) in an amount corresponding to a weight ratio of NaOCl (as Cl₂) to said HBr in said solution A of from about 0.3 to about 0.9. Said solutions in the technology and in the system according to the invention are combined to produce a biocidal composition having an acidic pH and containing active halogen of less than 20 wt %. Said solutions may be combined before or after said treatment, for example before or after contacting said treated industrial waters or other treated objects. Said solutions may be diluted with water before being combined. In one aspect, the invention provides a kit for treating industrial waters or industrial water systems, comprising two solutions, which may be combined before the intended use, solution A containing HBr at a concentration of between 5 wt % and 30 wt % and urea at a weight ratio of urea/HBr of at least 0.3 and not higher than 3, and solution B containing sodium hypochlorite (NaOCl) in an amount corresponding to a weight ratio of NaOCl (as Cl₂) to said HBr in said solution A of from about 0.3 to about 0.9.

### DETAILED DESCRIPTION OF THE INVENTION

It has now been found that biologically contaminated waters can be very efficiently treated by combined effects of active halogen content at acidic pH, comprising admixing concentrated components, or a mixture thereof, into the treated water, the components being selected from urea, acid such as HBr, urea acidic salt, and an oxidizer, where the biocidal species are formed before or after contacting said components with said contaminated waters, for example in situ. For example, a commercial oxidizer, such as hypochlorite, in the presence of urea and HBr may provide the biocidal effects.

The method and the biocidal composition of the invention provide persistent killing effect and they prevent the development of biofilms even after long time periods, as experimentally demonstrated.

In a preferred embodiment, the method of the invention comprises contacting the treated volume or surface with at least two liquid streams, one of which comprises an aqueous solution of HBr with urea and the other a commercial oxidizer, such as alkali sodium hypochlorite.

The method enables to handle even the most arduous biofouling agents, while avoiding the direct use of elemental halogens, or the use of alkali solutions when desired. Simple stable stock solutions may be combined before the desired treatment, comprising, for example, stock solution of HBr mixed with urea, and stock solution of concentrated NaOCl.

It is believed that the enhanced effects of the composition according to the invention have several reasons. Urea is believed to effectively mediate the oxidizing effects by binding at least a part of the present active halogen in the form of bromourea. Unreacted HBr renders the composition strongly acidic, which by itself would neutralize a part of the biofouling agents. Synergistically, the low pH combines with the oxidizing effects of the active halogen.

The invention provides a method of treating volumes or surfaces to eliminate or prevent biofouling, while employing concentrated stock solutions of stable precursors that are able to produce biocide species on site from relatively smaller volumes. Compared with many known methods which use unstable or dangerous or environmentally damaging chemicals, the method according to the invention comprises safe transport of concentrated solutions, which are, moreover, stable on prolonged storage. The method according to the invention enables to make anti-biofouling activities more efficient at lower cost.

The invention is directed to a method providing a biocidal and anti-biofouling composition for treating any one of industrial and agricultural water, a system containing industrial and agricultural water, and meat or poultry. The invention is also directed to a process of preventing or eliminating biofouling in industrial waters, like cooling towers, in pulp and paper industry, in production aqueous streams, in effluent water, in irrigation systems and agricultural applications, in meat and poultry manufacture, or the like. The waters may be treated in static containers or in dynamic streams. In one embodiment, the stream comprises production circuits in paper mill, for example comprising pulp slurry. The treatment may be applied in an effluent to be released from an industrial process. Generally, the method and the composition of the invention are useful in treating waters which are intermediate or terminal streams in industrial and agricultural processes. The aqueous mixtures to be treated according to the invention may, for example, comprise industrial waters selected from cooling water, water for agricultural use, water in paper mill process, or waste water.

The instant method enables to lower the volumes of reagents employed in anti-biofouling treatments. Both the volumes of reagents injected into the treated waters and the volumes of stock solutions are reduced, simplifying storage, transport and handling.

The invention is directed to a biocidal technology and to its use in treating industrial waters, the technology comprising two aqueous solutions, A and B, the former containing HBr at a concentration of between 5 wt % and 30 wt % and urea at a weight ratio of urea/HBr of from 0.3 to about 3, the ratio preferably being at least 1, and the latter containing sodium hypochlorite (NaOCl) in an amount corresponding to a weight ratio of NaOC1 to said HBr in said solution A of from about 0.3 to 0.9; wherein said solutions are combined to produce a biocidal composition having an acidic pH and containing active halogen of less than 20 wt %. Said solutions may be combined before or after contacting said industrial waters. Said solutions may be optionally diluted with water before being combined. If a solution A contains, for example, 10 wt % HBr and 15 wt % urea, and a solution B contains 8 wt % NaOCl (as Cl₂), the two solutions may constitute a kit for treating industrial waters or industrial water systems, comprising two components which are combined before or during the intended use in equal volumes, or in streams having the same flow rates, with or without a third stream of water for dilution.

The invention relates to a method for making a biocidal composition for treating industrial waters, comprising i) providing aqueous solution A containing HBr at a concentration of between 5 wt % and 30 wt % and urea at a weight ratio of urea/HBr of from 0.3 to about 3, ii) providing solution B containing sodium hypochlorite (NaOCl) in an amount corresponding to a weight ratio of NaOCl to said HBr in said solution A of from about 0.3 to 0.9; and iii) combining said solutions A and B to produce a biocidal composition having an acidic pH and containing active halogen of less than 20 wt %. A person skilled in the art of biocidal compositions might replace hydrobromic acid in said solution A, partially or fully, by other suitable acid and an alternative source of bromide, for example by phosphoric or sulfuric acid in a suitable concentration and NaBr, preferably considering cheap technical grades, but in the most preferred embodiment of the invention, HBr is mainly used. A person skilled in the art of biocidal compositions might replace sodium hypochlorite in said solution B, partially or fully, by other suitable oxidant, for example by DB-DMH, BC-DMH, DB-MEH, and LiOCl, or Ca(OCl)₂ in a suitable concentration, but in the most preferred embodiment of the invention, NaOCl is mainly used.

### EXAMPLES

### Example 1

Solution A: In a 100 ml flask, urea was dissolved (17.05 g) in 59.05 g water, followed by the addition of 23.9 g of 48% aqueous HBr (urea 17 wt %, HBr 11.5 wt %). The pH was −0.52. Solution B: 45 g of an aqueous commercial NaOCl solution (11.2 wt % Cl₂). Solution A and solution B were added simultaneously during 10 min into a 500 ml round bottom flask containing water (360 g) and equipped with a magnetic stirrer. Ratio urea/HBr was about 1.5, ratio NaOC1/HBr was about 0.5. An orange solution was obtained (pH 1.25), showing an absorption at 267 nm (UV). Iodometric titration detected 2.3 wt % active bromine.

### Example 2

Solution A: In a 100 ml flask, urea was dissolved (12.8 g) in 75.3 g H2O, followed by the addition of 11.95 g of 48% aqueous HBr (urea 12.8% wt %,

HBr 5.75 Wt %). The pH was 1.05. Solution B: 38.3 g of an aqueous commercial NaOC1 solution (13.2 wt % as Cl₂). Solution A and solution B were added simultaneously during 5 min to a 1000 ml round bottom flask containing water (870 g) and equipped with a magnetic stirrer bar. Ratio urea/HBr was about 2.2, ratio NaOCl/HBr was about 0.9. An orange solution was obtained, (pH 2.5), showing an absorption at 265-7 nm (UV). Iodometric titration detected active bromine of 0.7 wt %. The addition of water was done in order to simulate the dilution of the composition when used in streams, but more concentrated mixtures can be obtained.

### Example 3

Solution A: Solid urea (174.0 g) was dissolved in water (80 g) and in an aqueous solution of 48% HBr (244.3 g; 117.3 g as pure) to obtain 584.3 g (urea-41.6% wt %, HBr-28.03% wt %). Solution B: An aqueous solution of 10.3% NaOCl (1000 g, 103 g as Cl2). The two solutions were added dropwise in parallel to obtain a yellowish solution of bromourea (1418.3 g).

### Example 4

Solution A: Solid urea pure (260 g) was dissolved in an aqueous solution of aqueous 48% HBr (244.3 g, 117.3 g as pure) to obtain 584.3 g (urea-44.5%, HBr-20.07%). Solution B: An aqueous solution of 10.3% NaOCl (1000 g, 103 g as Cl2) The two solution were added dropwise in parallel to obtain a yellowish solution of biocidal efficacy (1584.3 g).

While the invention has been described using some specific examples, many modifications and variations are possible. It is therefore understood that the invention is not intended to be limited in any way, other than by the scope of the appended claims.

1. A method for manufacturing a biocidal and antifouling composition in an aqueous mixture, comprising the steps of
i) providing aqueous solution A containing HBr at a concentration of between 5 wt % and 30 wt %, and urea at a weight ratio of urea/HBr of at least 0.3;
ii) providing aqueous solution B comprising sodium hypochlorite (NaOCl); and
iii) combining said aqueous solutions A and B;
wherein said weight ratio of urea/HBr is not higher than 3, and wherein said solutions A and B are combined, optionally with an amount of additional water, in such a volume ratio so as to provide a pH lower than 6.0.

2. A method for manufacturing a biocidal and antifouling composition in an aqueous mixture according to claim 1, for treating industrial waters, comprising the steps of
i) providing aqueous solution A containing HBr at a concentration of between 5 wt % and 30 wt %, and urea at a weight ratio of urea/HBr of at least 0.3;
ii) providing aqueous solution B containing NaOCl in an amount corresponding to a weight ratio of NaOCl (as Cl₂) to said HBr in said solution A of from 0.3 to 0.9; and
iii) providing said aqueous mixture by combining a quantity of said aqueous solutions A and B with an amount of additional water;
wherein said solutions A and B create an acidic pH in said aqueous mixture and active bromine in a concentration of less than 20 wt %.

3. A method according to claims 2, wherein said amount of additional water in said step iii) produces an aqueous mixture containing active bromine in a concentration of between 0.1 wt % and 12.5 wt %.

4. A method according to claims 3, wherein said aqueous mixture is employed as a stock solution and is admixed into industrial or agricultural water needing anti-fouling treatment.

5. A method according to claims 2, wherein said amount of additional water in said step iii) is higher than said quantity of solutions A and B, said aqueous mixture containing active bromine in a concentration of 0.1 to 10 ppm.

6. A method according to claims 5, wherein said solutions A and B are injected into a tank or into a circuit comprising industrial or agricultural water needing anti-fouling treatment.

7. A method according to claim 2, wherein said aqueous mixture comprises a water bulk or a water stream, and wherein said combining solutions A and B comprises their mixing or their addition to said aqueous mixture in any order.

8. A method of manufacturing a biocidal and antifouling composition in an aqueous mixture according to claim 2, comprising steps of
i) admixing solution A into said aqueous mixture, wherein said solution A contains HBr at a concentration of between 5 wt % and 30 wt % and urea at a weight ratio of urea/HBr of at least 0.3 and not higher than 3; and
ii) admixing solution B into said aqueous mixture, wherein said solution B contains NaOCl in an amount corresponding to a weight ratio of NaOCl (as Cl₂) to said HBr in said solution A of from 0.3 to 0.9;
thereby creating a pH of 3.5 or less in said aqueous mixture and active bromine at a concentration up to 20 wt %.

9. A method according to claim 8, comprising admixing hydrobromic acid into water or into an aqueous mixture of urea, wherein said hydrobromic acid is added as a gas or as a water solution.

10. A method according to claim 8, comprising admixing urea into water or into an aqueous solution of HBr, wherein said urea is added as a solid or as a water solution or suspension.

11. A method according to claim 1, comprising admixing solid urea into an aqueous solution of HBr.

12. A method according to claim 8, comprising admixing NaOCl into a water solution comprising HBr and urea, wherein said NaOCl is added as an alkali water solution.

13. A method according to claim 8, wherein said biocidal and antifouling composition has a pH of 2.5 or less.

14. A method according to claim 8, wherein said urea/HBr ratio is between 1.5 and 2.5.

15. A method according to claim 8, comprising
i) admixing hydrobromic acid (HBr) and urea into water or aqueous mixture, wherein the amount of admixed HBr corresponds to a final concentration of between 10 wt % and 30 wt %, and wherein the amount of admixed urea corresponds to a weight ratio of urea/HBr of at least 0.3 and not more than 3, thereby obtaining a solution having a pH of 0.0 or less; and
ii) admixing NaOCl into said aqueous mixture or into the solution obtained in step i) in an amount corresponding to a weight ratio of NaOCl (as Cl₂)/HBr of between 0.3 and 0.9;
thereby obtaining an aqueous solution comprising up to 20 wt % active bromine and a pH of 1.5 or less.

16. A method according to claim 8, comprising
i) admixing hydrobromic acid (HBr) and urea into water or aqueous mixture, wherein the amount of admixed HBr corresponds to a final concentration of between 5 wt % and 10 wt %, and wherein the amount of admixed urea corresponds to a weight ratio of urea/HBr of between 2 and 3, thereby obtaining a solution having a pH of 1.5 or less; and
ii) admixing NaOCl into said aqueous mixture or into the solution obtained in step i) in an amount corresponding to a weight ratio of NaOCl/HBr of between 0.3 and 0.9;
thereby obtaining an aqueous solution comprising up to 8 wt % active bromine and a pH of 2.5 or less.

17. A method according to claim 8, comprising combining at least two liquid streams, one of which comprises aqueous solution of HBr and the other aqueous solution of NaOCl.

18. A method according to claim 17, comprising combining at least two liquid streams, one of which comprises aqueous solution of HBr and urea, and the other aqueous solution of NaOCl.

19. An aqueous biocidal and antifouling composition comprising a mixture of hydrobromic acid (HBr), urea, and sodium hypochlorite (NaOCl), wherein said HBr is added to the mixture as a solution having a concentration of between 5 wt % and 30 wt %, urea is added as a solution having a concentration such as to provide a weight ratio of urea/HBr of at least 0.3 and not more than 3; and NaOCl is added as a solution having a concentration such as to provide a weight ratio of NaOCl (as Cl₂)/HBr of between 0.3 and 0.9.

20. A biocidal and antifouling composition according to claim 19, comprising active bromine at a concentration up to 20 wt %.

21. A biocidal and antifouling composition according to claim 19, having a pH of 3.0 or less.

22. A biocidal and antifouling composition according to claim 19, acting synergistically against biofouling agents by means of active halogen and high acidity, having an active bromine of at least 12.5 wt % and a pH of 3 or less.

23. A biocidal and antifouling composition according to claim 19, comprising HBr from 4 to 12 wt %, urea from 4 to 16 wt %, active bromine from 2 to 8 wt %, and a pH of 3.0 or less.

24. A biocidal and antifouling composition according to claim 19, comprising HBr from 4 to 12 wt %, urea from 4 to 16 wt, total chlorine from 1 to 4 wt %, and a pH of 3.0 or less.

25. A method according to claim 2, wherein said aqueous mixture comprises industrial waters selected from cooling water, water for agricultural use, effluent water, water in paper mill process, industrial process water, production aqueous stream, irrigation water, or waste water.

26. A biocidal technology for treating industrial waters, production aqueous streams, cooling towers, waters in pulp and paper industry, effluent waters, irrigation systems and agricultural equipments, and meat and poultry products, comprising two aqueous solutions, A and B, the former containing HBr at a concentration of between 5 wt % and 30 wt % and urea at a weight ratio of urea/HBr of at least 0.3 and not higher than 3, and the latter containing sodium hypochlorite (NaOCl) in an amount corresponding to a weight ratio of NaOCl (as Cl₂) to said HBr in said solution A of from about 0.3 to about 0.9.

27. A technology according to claim 26, wherein said solutions are combined to produce a biocidal composition having an acidic pH and containing active halogen of less than 20 wt %.

28. A technology according to claim 26, wherein said solutions are combined before or after said treatment.

29. A technology according to claim 26, wherein at least one of said solutions is diluted with water before being combined.
